(19) United States
(12) Patent Application Publication
(10) Pub. No.: US 2008/0300899 A1
(43) Pub. Date: Dec. 4, 2008

(54) Supply item replacement optimization in imaging devices

(75) Inventors: Rickey C. Brown, Bardstown, KY (US); Kevin D. Schoedinger, Lexington, KY (US); Mike Partington, Lexington, KY (US); David V. Snow, JR., Nicholasville, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/807,897

(22) Filed: May 30, 2007

(51) Int. Cl. G06Q 10/00

(52) U.S. Cl. 705/1

(57) ABSTRACT

In an imaging device, methods for managing replacement of supply items include providing users with one or more adjustable variables so they may balance individual image quality needs versus economic costs of purchasing new supply items. Representatively, users are provided with a first adjustable variable indicative of a countdown value of media remaining to be imaged before the imaging device ceases imaging and a second adjustable variable indicative of an amount of imaging material remaining that corresponds to a low warning threshold. Upon reaching the low warning threshold, users are messaged with the countdown value. Thereafter, the first variable is decremented per each media imaged and the decremented value is displayed to users to indicate a number of pages remaining before device shutdown (or before needing to replace the supply item).

### FIELD OF THE INVENTION

Generally, the present invention relates to imaging devices, such as laser printers, copy machines, fax machines, inkjet printers, all-in-ones, etc. Particularly, it relates to supply items of the imaging device and determining their optimal time for replacement. In one aspect, imaging material and media countdown thresholds are made user-variable according to need. In another, conflicting goals of image quality versus economic costs are balanced. Modes of device operation, countdown-to-empty, and computing environments, to name a few, are other noteworthy features.

### BACKGROUND OF THE INVENTION

Imaging devices have long been known for providing hard copy outputs of text, pictures, etc., by way of affixing toner, ink or other imaging material on media, such as paper, transparencies, or the like. Because the cartridge or housing carrying the imaging material, e.g., the supply item, depletes over time, users continually need to replenish their imaging material. Sometimes this includes replacing a spent cartridge with a fresh cartridge, or filling a spent cartridge with an off-carrier bulk supply of imaging material. In either, a problem facing users is determining an optimal time for replacement.

Typically, users balance the competing goals of image quality and economic costs. In the former, image quality suffers as the supply item depletes, i.e., the imaged output on the media becomes visibly lighter. In the latter, the more media a user can image with a single supply item cartridge before replacement equates to a lower overall cost per-page printed. The optimal point of replacement, however, is subjective and differs from user to user. It depends on factors such as each user's level of tolerance for what is considered an acceptable print quality in exchange for the cost expended to achieve that print quality. For example, a user who only images in-house documents (such as memos, work orders, etc.) may choose to emphasize economy of printing at the expense of print quality (as the imaged media need only be legible, but not necessarily high quality). On the other hand, a user who images sales brochures for external customers may desire imaged media of the highest quality even if it means swapping supply items before they are completely empty to avoid any quality degradation, such as when the supply item is in a “Low” state (as is regularly displayed to users on control panels of imaging devices).

While a single user with a dedicated imaging device (e.g., one who does not share with others) can examine each media for acceptable print quality as it is imaged, and immediately and easily determine when to replace the supply item, users in larger environments have difficulty. Namely, multiple users might need to collectively determine when the optimal time is to replace a supply item, with each having competing interests. Sharing a single imaging device may also mean that certain users are unaware that supply items need replacement, in that the device may be located far away from their workstation and imaged media sit for extended periods of time before being gathered or inspected by the user. The problem becomes exacerbated when lengthy documents are imaged (e.g., hundreds or thousands of pages). For example, if such a document begins imaging with the onset of a “Low” state in the supply item, the initial media of the document may be of an acceptable print quality, while the latter media may begin to fade in quality as the imaging material runs low—even possibly to the point of the media being virtually blank.

Current methods for overcoming these issues involve the imaging device posting a toner or ink “Low” message on the operator panel (possibly with corresponding alerts and/or emails to users at workstations). The time for posting also occurs when the device enters a state where the optimal print quality can no longer be guaranteed. (However, few users actually replace the supply item at this point, because typically the print quality has not yet begun to visibly degrade.) Some imaging devices offer a further message (“Empty”) at which point the device stops imaging altogether until the user replaces the supply item. However, typically the supply item is still not completely empty, so this can prove frustrating for the user who may not have a spare supply item readily available and simply needs to finish a pending imaging job where print quality is not important.

Engineers at manufacturing companies of these imaging devices determine the thresholds (e.g., “Low” and “Empty”). They often program in a “one size fits all” fashion. But the problem is that there is not a scientifically determinable exact point for either threshold value, so the value is often engineered to the conservative side. Intuitively, these values may not then meet the exact needs of any one individual user or entity.

Accordingly, a need exists in the art of imaging devices to tailor supply item replacement to individual needs. It further contemplates more closely tying existing imaging device thresholds of “Low” and “Empty” according to the user's individual needs. Precise user feedback regarding actual numbers of media pages the device can image until the “Empty” threshold is actually reached (at which point the user must replace the supply item in order to continue imaging) is still another consideration. Naturally, any improvements along such lines should further contemplate good engineering practices, such as relative inexpensiveness, stability, ease of implementation, low complexity, security, unobtrusiveness, etc.

### SUMMARY OF THE INVENTION

The above-mentioned and other problems become solved by applying the principles and teachings associated with the hereinafter described supply item replacement optimization for imaging devices. In a basic sense, users are given adjustable thresholds over their supply items to self-regulate image quality versus economic cost of the supply item. To name a few, a “Low” threshold and “page countdown value” are given to users to self-adjust when a supply item needs replacement.

In one embodiment, users are provided with a first adjustable variable indicative of a countdown value of media remaining to be imaged before the imaging device ceases imaging and a second adjustable variable indicative of an amount of imaging material remaining that corresponds to a low warning threshold. Upon reaching the low warning threshold, users are messaged with both the low warning and the countdown value. Thereafter, the first variable is decremented per each media imaged and the decremented value is displayed to users to indicate a number of pages remaining before shutdown (or before needing to replace the supply item). Other embodiments contemplate tracking multiple variables amongst multiple supply items, or indicating whether a media count of a print job can be processed by the imaging device before depletion of the imaging material. Still other embodiments contemplate enabling user bypass of the functionality of the variables, or providing users with other variables indicative of an empty amount of the imaging material. Modes of device operation and computing environments are other noteworthy features.

These and other embodiments, aspects, advantages, and features of the present invention will be set forth in the description which follows, and in part will become apparent to those of ordinary skill in the art by reference to the following description of the invention and referenced drawings or by practice of the invention. The aspects, advantages, and features of the invention are realized and attained by means of the instrumentalities, procedures, and combinations particularly pointed out in the appended claims.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a diagrammatic view in accordance with the teachings of the present invention of an imaging device in the form of a laser printer having various supply items;

FIG. 2 is a diagrammatic view in accordance with the teachings of the present invention of a representative supply item for use with the imaging device of FIG. 1;

FIG. 3 is a flow chart in accordance with the teachings of the present invention indicating a replacement strategy for the supply items of imaging devices; and

FIG. 4 is a diagrammatic view in accordance with the teachings of the present invention of a representative computing environment using the supply item replacement strategy.

### DETAILED DESCRIPTION OF THE ILLUSTRATED EMBODIMENTS

In the following detailed description of the illustrated embodiments, reference is made to the accompanying drawings that form a part hereof, and in which is shown by way of illustration, specific embodiments in which the invention may be practiced. These embodiments are described in sufficient detail to enable those skilled in the art to practice the invention and like numerals represent like details in the various figures. Also, it is to be understood that other embodiments may be utilized and that process, mechanical, electrical, arrangement, software and/or other changes may be made without departing from the scope of the present invention. In accordance with the present invention, a supply item replacement strategy in an imaging device is hereinafter described.

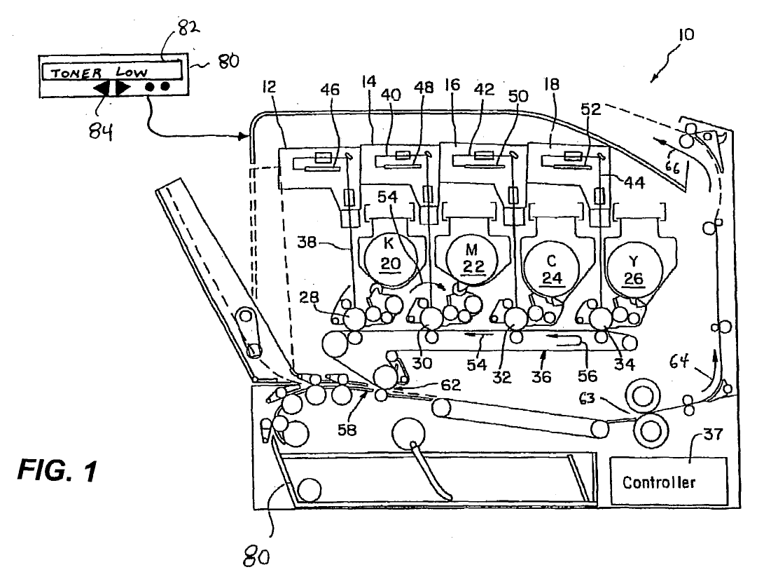

With reference to FIG. 1, a representative imaging device is typified by a laser printer indicated generally by the numeral 10. The device includes a plurality of supply items in the form of optionally removable toner cartridges 20, 22, 24 and 26 and each has a different colored toner (C, M, Y, and K). An intermediate transfer member (belt 36) is also present as are laser print heads 12, 14, 16 and 18 and one or more recording media supply trays 80. During use, each of the laser print heads projects a respective laser beam 38, 40, 42, 44 from a respective laser source 46, 48, 50 and 52. As a polygon mirror, oscillator or other scanner mechanism moves, it scans a respective reflected laser beam across a respective photoconductive drum 28, 30, 32 and 34 to create a latent to-be-printed image. The image data is received from a controller 37, in turn, supplied from an external computing device, such as a special or general purpose computer, cell phone, PDA, scanner, memory card, camera, etc.

To develop the images, toner in each of the cartridges is transferred to the photoconductive drums by appropriately biased voltages and then transferred to a media (hard copy output) or an intermediate transfer member and then to the media. In this case, toner from cartridges 20, 22, 24 and 26 is brought into contact with a respective one of photoconductive drums 28, 30, 32 and 34 which, in turn, is transferred to a belt 36 rotating in the direction indicated by arrow 56. As a print medium, such as paper, travels along path 58 from tray 80, the toner is transferred to the surface of the print medium in a nip 62. Thereafter, the media is advanced in the direction of arrows 64, 66 (and fused along the way at nip 63) to provide an output hard-copy to users.

A control panel 80 is provided for display of messages, such as “Toner Low,” on a display 82. Various bulbs or LEDs may also light to provide various messages or indications to users. One or more user buttons 84 enable the user to interface with the controller to make selections, change or enter user-adjustable variables, cancel print jobs, or the like. Similar functionality may also exist in menus on a display of a computer monitor described below. The controller may be an Application Specific Integrated Circuit (ASIC), microprocessor, a collection of dedicated electronic chips, such as on a printed circuit board (PCB), or other. It may even be a collection of the foregoing.

In other embodiments, the imaging device of the invention is a copy machine, fax machine, inkjet printer, all-in-one, etc. Supply items are then either toner or ink cartridges. A laser printer and toner cartridge will be described hereafter as representative of all imaging devices and supply items.

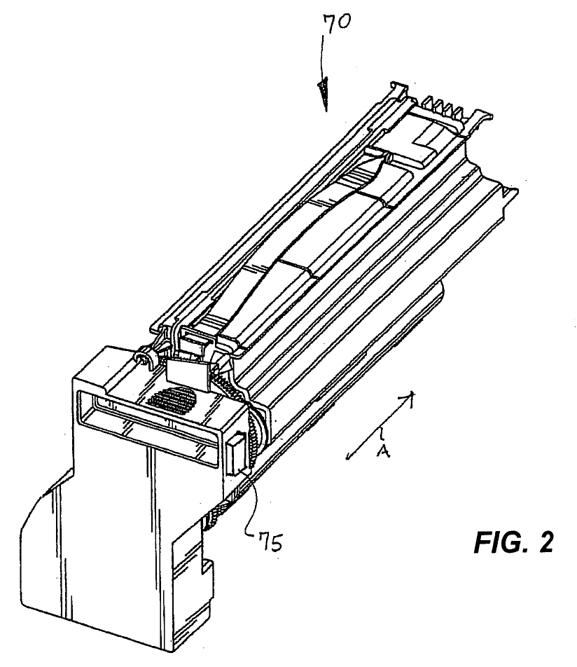

With reference to FIG. 2, a generic toner cartridge for inclusion in the imaging device of FIG. 1 is seen generally as 70. It has a longitudinal extent and slides transversely into the device in a direction of Arrow A. Further, it includes a smart chip or other memory device 75 useful in storing various data, such as is relevant to printing, like an amount of toner remaining in the cartridge, or that is relevant to the cartridge, like a cartridge serial number, age of the cartridge, etc. It may also store the user variables described below or updated versions of the variables. During use, it communicates with the controller 37 (FIG. 1) to effectuate printing, as is well known.

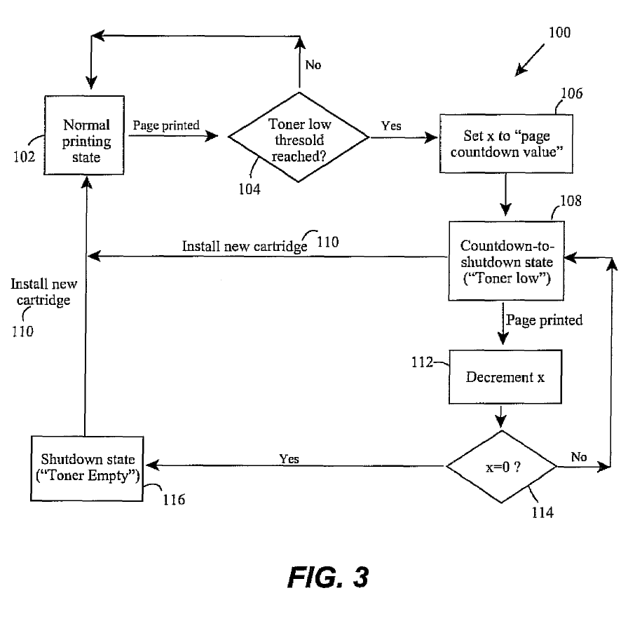

In FIG. 3, a high level organization for replacing a supply item in an imaging device is given as 100. For modes of operation, the supply item is identified as being in one of three states: 1—normal imaging or printing state; 2—countdown-to-shutdown state (or: “Low” state, “Toner Low” state, or “Ink Low” state, etc.); or 3—shutdown state (or: “Empty” state, “Toner Empty” state, or “Ink Empty” state, etc.). For purposes of these states, the supply item in effect dictates the state of the imaging device. For example, if the supply item in a laser printer is in a normal printing state, this means the printer itself is also in a normal printing state. If the supply item is in a “countdown-to-shutdown” state, then the printer is in this same state. If the supply item is in a “shutdown” state, then the printer is effectively shut down and imaging media is ceased.

Two user-adjustable variables (which may be stored wholly or partially in printer memory associated with the controller or smart chip, or both) are provided:
1. A “Low” threshold (in terms of approximate percentage of imaging material, e.g., toner left in a cartridge) is a variable that the user sets for the printer, such as via the control panel or via datastream commands (such as PJL or NPA). In function, the supply item continually communicates to its respective imaging device an amount of remaining imaging material (ink or toner). Once the imaging material reaches this “Low” threshold, it triggers a transition from the normal imaging or printing state into the countdown-to-shutdown state. The value actually set here by the user is dictated by individual needs of the user or the entity reflective of the tension between image quality and economic costs.
2. A “page countdown value” is a variable that the user sets for the printer and indicates a number of pages or media the imaging device will print or image before the device shuts down, e.g., enters into the “shutdown” state. Preferably, the number begins upon reaching the “Low” threshold, but may begin at other times, such as upon cartridge installation or other. This is also a variable that the user sets in the printer via the printer control panel or via datastream commands (such as PJL or NPA). The value actually set here is dictated by individual needs of the user or the entity employing users reflective of the tension between image quality and economic costs.

Turning to the flow chart, the imaging device begins operations with a full supply item and does so in a normal imaging or printing state 102. By way of various feedback sensors, such as mechanical torque arms and/or optical sensors in the supply item (as are well known), a percentage remaining of toner or ink in the supply item is made known to the imaging device. Upon reaching the “Low” threshold amount at step 104 (previously set by the user) the imaging device transitions from the normal printing state 102 to the countdown-to-shutdown state 108. (On the other hand, the normal printing state continues if the “Low” threshold has not yet been reached at step 104.) At such time, the imaging device posts a “Toner Low—x pages left until shutdown” message on the control panel (where “x” is initially set to the page countdown value) and issues a corresponding “Toner Low” user alert and/or email, if appropriate. Once this threshold is crossed, the printer begins to count each page printed until the user-adjustable “page countdown value” number of pages have been printed (or until the cartridge is replaced at step 110—whichever comes first). The “x” in the control panel message represents the number of pages that the printer will print before shutting down (unless the cartridge is replaced beforehand). For example, if a user selects a page countdown value of 800, then “800 pages left until shutdown” appears in the message of the control panel upon reaching the “Low” threshold. Upon the printing of a single page thereafter, the message changes to “799 pages left until shutdown,” e.g., 800−1=799, until eventually all pages have been printed. In this manner, users can dictate to the imaging device whether print quality or economic costs are more important during use. In flow, “x” starts at the page countdown value and then decrements (step 112), such as by counting down by one (for each simplex page printed) or by two (for each duplex page printed), until it reaches zero, step 114.

Once the countdown number of pages has printed and the value “x” on the panel has reached zero, the imaging device has reached the shutdown state, step 116. The imaging device posts a “Toner Empty—replace cartridge to continue” or similar message on the control panel and issues a corresponding “Toner Empty” alert and email, if appropriate. At this point the printer will also shutdown (i.e., cease printing). The only way to exit this state is to replace the cartridge with a new cartridge 110 (that has not already reached the shutdown state). When a new cartridge is installed, the printer returns to the normal printing state at step 102. The process continues for the life of the imaging device (if desired, in that an option described below contemplates a bypass of functionality).

As before, the state of the installed supply item dictates the state of the imaging device and when a cartridge is replaced, the printer will enter the state of that replacement cartridge. Ideally, a replacement cartridge is a new cartridge such that inserting a new cartridge will return the printer to the “normal printing state.” However, it is also possible that a user could insert a cartridge into the printer that was previously installed in this same or other printer (i.e., a used cartridge) and is already in either a “countdown-to-shutdown” state or a “shutdown” state. In these situations, the cartridge state and the imaging device state must be reconciled—after which the imaging device then enters the respective state of the cartridge.

For example, a new cartridge would initialize its uninitialized internal variables (low threshold, page countdown value) to match those of the imaging device in which it is installed. On the other hand, a used cartridge would potentially already have its internal variables (low threshold, page countdown value) initialized from the last imaging device in which it was installed. If the used cartridge is in a “countdown-to-shutdown” state or a “shutdown” state, it would also have an additional internal variable initialized: “current number of pages left to be printed until the shutdown state.” (Note that this variable would be equal to zero if the cartridge was in the “shutdown” state.) If a used cartridge is installed into an imaging device that has the same low threshold and page countdown value settings as the used cartridge (as would typically be the case when installing the used cartridge back into the imaging device in which it was previously installed), then no variable reconciliation is required. However, if the used cartridge variables and the imaging device variables are not the same, then the cartridge variables must be reconciled to the imaging device variables (to determine the state of that cartridge in relation to the imaging device's internal variables—which reflect the expectations of the user).

As a math example of this, consider a new, first cartridge installed in an imaging device with a page countdown value set to 1000 and a toner low threshold of 10%. The new cartridge will initialize its page countdown value to 1000 and its toner low threshold to 10% to match the values of the imaging device's variables. Now consider this cartridge being replaced when x=400 pages remaining until entering the shutdown state. In other words, replacement occurred after 600 pages of the first cartridge were printed in the countdown-to-shutdown state. Upon insertion of a used, second cartridge having its toner low threshold variable set to 10% and its page countdown value set to 1200 pages, with only 200 pages having been printed since reaching the “Low” threshold, the message on the control panel to the user would self adjust for the second cartridge and display “1000 pages left until shutdown,” or 1200 minus 200, instead of the earlier displayed message of the first cartridge “400 pages left until shutdown,” or 1000 minus 600. In addition, the internal variables of the second cartridge would be modified to reconcile them with the variables of the imaging device; i.e., the second cartridge's page countdown value would be changed from 1200 to 1000. In this example, the cartridge's “current number of pages left to be printed until the shutdown state” variable would remain at 1000 pages. (Note that these variable reconciliation calculations become considerably more complex in cases when (a) the used cartridge's toner low threshold value does not match that of the imaging device in which it is installed, and (b) the used cartridge is not in a normal printing state.)

Alternatively, a user may change their preferred settings per a single cartridge and adjust a page countdown value from 1200 pages to 1000 pages. In such instance, the controller again self corrects and, to the extent 800 pages were already printed in the “countdown-to-shutdown” state, the message to users would adjust from “400 pages left until shutdown,” or 1200 first set value minus 800 pages printed, to “200 pages left until shutdown,” or 1000 adjusted value minus 800 pages printed.)

With the foregoing in mind, skilled artisans will readily contemplate alternate embodiments. In a first option, an imaging device automatically tracks habits of users that reconciles set variables according to past user inputs.

In a second option, information technology (IT) or other personnel may altogether bypass this functionality in those instances when page tracking is undesired. To accomplish this, supply items may be designed with a hard switch or electronic entry can occur by way of the imaging device's control panel or other software in a computing device attendant with the imaging device.

In a third option, various alerts, such as emails, can be sent to an IT administrator to track the countdown remotely. When the supply item is near the end of its life, supply personnel can be notified to order replacements. Email or other alerts should likely include the capability to adjust the frequency of the receipt such as per every 50 pages printed, every 100 pages, etc.

In a fourth option, the countdown-to-shutdown process can be integrated with an internal toner coverage estimator that tracks the average toner coverage of the pages printed and adjusts the countdown values accordingly. As an example, U.S. patent application Ser. No. ______, entitled “Methods and Apparatuses for Determining the Number of Printed Pages Remaining in a Toner Cartridge,” having common assignee Lexmark International, Inc., teaches such an estimator and is hereby incorporated by reference in its entirety.

In a fifth option, a toner coverage estimator could be used in an automatic mode of operation to control or simply provide feedback on the afore-mention user-adjustable variables.

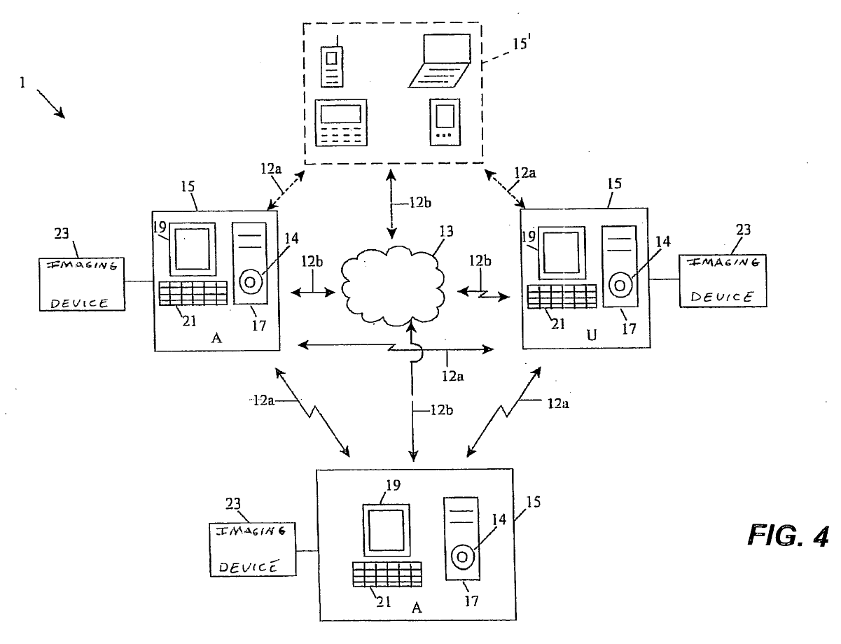

In a sixth option, it is a feature to provide advance warning alerts to users when a media count of an imaging job size is larger than the remaining pages left in a cartridge until shutdown. Not only could this consist of informing users, thereby allowing them to cancel the print job preemptively or replace the toner cartridge, but may also consist of redirecting of the print job from one imaging device to another along with email messages. A computing system environment is then contemplated in FIG. 4, described below, having multiple such imaging devices interconnected with one another.

In a seventh option, users are allowed to set a “shutdown” threshold. For example, the user could set the “Low” threshold to 10% and a “shutdown” threshold to 3% to compensate for coverage variation. In conjunction with the internal toner coverage estimator function, one could post “estimated number of pages until shutdown” on the control panel (not to be confused with the exact page countdown value x described above). In this manner, a hard stop of printing occurs at the 3% threshold despite the 10% threshold and the page countdown value.

With reference to FIG. 4, a representative computing environment 1 for replacing supply items in imaging devices in a network includes one or more computing devices 15 or 15′ available per users. In a traditional sense, an exemplary computing device typifies a server 17, such as a grid or blade server, or peer-to-peer arrangement, etc. Alternatively, an exemplary computing device includes a general or special purpose computing device in the form of a conventional fixed or mobile computer 17 having an attendant monitor 19 and user interface 21. The computer internally includes a processing unit for a resident operating system, such as DOS, WINDOWS, MACINTOSH, VISTA, UNIX and LINUX, to name a few, a memory, and a bus that couples various internal and external units, e.g., imaging device 23, to one another. In addition, other items (also available per each of the users) include, but are not limited to, PDA's, cameras, scanners, microphones, joy sticks, game pads, satellite dishes, hand-held devices, consumer electronics, minicomputers, computer clusters, main frame computers, a message queue, a peer machine, a broadcast antenna, a server, a grid-computing node, a virtual machine, a web service endpoint, a cellular phone or the like. The other items may also be stand alone computing devices 15′ in the environment 1.

In either, storage devices are contemplated and may be remote or local. While the line is not well defined, local storage generally has a relatively quick access time and is used to store frequently accessed data, while remote storage has a much longer access time and is used to store data that is accessed less frequently. The capacity of remote storage is also typically an order of magnitude larger than the capacity of local storage. Regardless, storage is representatively provided for aspects of the invention contemplative of computer executable instructions, e.g., code or software, as part of computer program products on readable media, e.g., disk 14 for insertion in a drive of computer 17, such as a printer driver. Computer executable instructions may also be available as a download or reside in hardware, firmware or combinations in any or all of the depicted devices 15 or 15′.

When described in the context of computer program products, it is denoted that items thereof, such as modules, routines, programs, objects, components, data structures, etc., perform particular tasks or implement particular abstract data types within various structures of the computing system which cause a certain function or group of functions. In form, the computer product can be any available media, such as RAM, ROM, EEPROM, CD-ROM, DVD, or other optical disk storage devices, magnetic disk storage devices, floppy disks, or any other medium which can be used to store the items thereof and which can be assessed in the environment.

In network, the computing devices communicate with one another via wired, wireless or combined connections 12 that are either direct 12a or indirect 12b. If direct, they typify connections within physical or network proximity (e.g., intranet). If indirect, they typify connections such as those found with the internet, satellites, radio transmissions, or the like, and are given nebulously as element 13. In this regard, other contemplated items include servers, routers, peer devices, modems, T1 lines, satellites, microwave relays or the like. The connections may be local area networks (LAN) and/or wide area networks (WAN) that are presented by way of example and not limitation. The topology is also any of a variety, such as ring, star, bridged, cascaded, meshed, or other known or hereinafter invented arrangement.

Certain advantages of the invention over the prior art should now be readily apparent. For example, imaging material and media countdown thresholds are made user-variable according to needs of individual users or entities. Conflicting goals of image quality versus economic costs are also balanced per individual needs. Modes of device operation, countdown-to-empty, and computing environments, to name a few, are further noteworthy.

One of ordinary skill in the art will recognize that additional embodiments are also possible without departing from the teachings of the present invention. This detailed description, and particularly the specific details of the exemplary embodiments disclosed herein, is given primarily for clarity of understanding, and no unnecessary limitations are to be implied, for modifications will become obvious to those skilled in the art upon reading this disclosure and may be made without departing from the spirit or scope of the invention. Relatively apparent modifications, of course, include combining the various features of one or more figures with the features of one or more of other figures. The present invention is not limited except as by the appended claims.

What is claimed:

1. A method of managing replacement of a supply item of an imaging device, comprising:
providing users of the imaging device with a first adjustable variable indicative of a media countdown value before the imaging device ceases imaging with the supply item.

2. The method of claim 1, further including providing the users of the imaging device with a second adjustable variable indicative of an amount of imaging material remaining in the supply item corresponding to a low warning threshold.

3. The method of claim 1, further including messaging the users of the media countdown value as each media is imaged by the imaging device.

4. The method of claim 2, further including determining a shutdown state of the imaging device based on the first and second adjustable variables.

5. The method of claim 1, further including tracking the first adjustable variable amongst multiple said supply items installed for use in the imaging device.

6. The method of claim 1, further including indicating whether a media count of a print job can be processed by the imaging device with the supply item before ceasing imaging based on the first adjustable variable.

7. The method of claim 1, further including bypassing the functionality of the providing the users with the first adjustable variable.

8. The method of claim 1, further including providing the users of the imaging device with a third adjustable variable indicative of an empty amount of imaging material of the supply item, upon reaching the empty amount the imaging device ceasing imaging despite a present value of the first adjustable variable.

9. In an imaging device for imaging a plurality of media with imaging material of multiple supply items, a method of managing replacement of said supply items, comprising:
installing one of the multiple supply items in the imaging device;
providing users of the imaging device with a first adjustable variable indicative of a countdown value of media remaining to be imaged before the imaging device ceases imaging with said one of the multiple supply items;
imaging at least one of said plurality of media; and
decrementing the countdown value.

10. The method of claim 9, further including messaging the users with the decremented said countdown value.

11. The method of claim 9, further including beginning imaging with the imaging device in an imaging state irrelevant of the countdown value.

12. The method of claim 11, further including providing the users of the imaging device with a second adjustable variable indicative of an amount of imaging material remaining in said one of the multiple supply items corresponding to a low warning threshold.

13. The method of claim 12, wherein the decrementing only begins upon reaching the second adjustable variable.

14. The method of claim 9, further including tracking the first adjustable variable amongst said multiple supply items installed for use in the imaging device.

15. The method of claim 9, further including indicating whether a media count of a print job can be processed by the imaging device with said one of the multiple supply items before ceasing imaging based on the first adjustable variable.

16. The method of claim 9, further including bypassing the functionality of the providing the users with the first adjustable variable.

17. The method of claim 9, further including providing the users of the imaging device with a third adjustable variable indicative of an empty amount of the imaging material of said one of the multiple supply items, upon reaching the empty amount the imaging device ceasing imaging despite a present value of the first adjustable variable.

18. The method of claim 9, further including storing the first adjustable variable in a smart chip of said one of the multiple supply items.

19. In an imaging device for imaging a plurality of media with imaging material of multiple supply items, a method of managing replacement of said supply items, comprising:
installing one of the multiple supply items in the imaging device;
providing users of the imaging device with a first adjustable variable indicative of a countdown value of media remaining to be imaged before the imaging device ceases imaging with said one of the multiple supply items;
providing the users of the imaging device with a second adjustable variable indicative of an amount of imaging material remaining in said one of the multiple supply items corresponding to a low warning threshold;
imaging said media in a first state until said second adjustable variable is reached;
messaging the users of the low warning threshold and the countdown value;
imaging at least one more media of said plurality of media;
decrementing the countdown value; and
messaging the users with the decremented said countdown value.

20. The method of claim 19, further including tracking the first adjustable variable amongst said multiple supply items installed for use in the imaging device.

21. The method of claim 19, further including indicating whether a media count of a print job can be processed by the imaging device with said one of the multiple supply items before ceasing imaging based on the first adjustable variable.

22. The method of claim 19, further including bypassing the functionality of the providing the users with the first and second adjustable variables.

23. The method of claim 19, further including providing the users of the imaging device with a third adjustable variable indicative of an empty amount of the imaging material of said one of the multiple supply items, upon reaching the empty amount the imaging device ceasing imaging despite a present value of the first adjustable variable.
